(19) United States
(12) Patent Application Publication
(10) Pub. No.: US 2025/0264843 A1
(43) Pub. Date: Aug. 21, 2025

(54) METHOD OF ASSEMBLING IMAGE FORMING APPARATUS AND IMAGE FORMING APPARATUS

(71) Applicant: CANON KABUSHIKI KAISHA, Tokyo (JP)

(72) Inventor: TETSUO FURUKAWA, Kanagawa (JP)

(21) Appl. No.: 19/052,913

(22) Filed: Feb. 13, 2025

(30) Foreign Application Priority Data
Feb. 16, 2024 (JP) 2024-021767

(51) Int. Cl. G03G 21/16; G03G 15/00

(52) U.S. Cl. CPC G03G 21/1647; G03G 15/657; G03G 21/1619

(57) ABSTRACT

An image forming apparatus includes a main body, a first part having a first and a second engaging portion, a second part having a first and a second engaged portion, and a third part. An assembling method includes a first step of engaging the first engaging portion of the first part with the first engaged portion of the second part by moving the first part in a first direction relative to the second part assembled into the main body; a second step of assembling the third part to the main body by moving the third part in a second direction; and a third step of moving the first part in a third direction relative to the second part so as to release the engagement between the first engaging portion and the first engaged portion and engaging the second engaging portion with the second engaged portion.

### BACKGROUND

### Field

The present disclosure relates to a method of assembling an image forming apparatus and an image forming apparatus.

### Description of the Related Art

Conventionally, in assembling parts into an image forming apparatus, a positioning portion and a locking portion are provided on the parts to prevent the parts from being displaced during assembly, allowing an assembly worker to take their hands off the parts and perform other tasks such as securing screws. For example, since the center of gravity of the part being assembled is not on the mounting surface, when the assembly worker takes their hands off the part, the part being assembled may fall off from the mounting surface. Therefore, Japanese Patent Application Publication No. 2003-063092 discloses a configuration in which a locking portion that can be positioned is provided on the part to hold the part on the mounting surface.

In Japanese Patent Application Publication No. 2003-063092, the parts being assembled cannot be moved after being placed on the image forming apparatus. Therefore, the technology of Japanese Patent Application Publication No. 2003-063092 could not be adopted when the parts assembled first are temporarily held at a position different from the assembly position, and the parts assembled later are moved and positioned after the assembly of the parts assembled later is completed. Here, when the image forming apparatus is made smaller, it becomes difficult to secure the assembly space, and a method of changing the assembly order of the parts may be adopted. Therefore, a method may be required in which the parts assembled first are temporarily held, and the assembly of the temporarily held parts is completed after the other peripheral parts are assembled.

### SUMMARY

The present disclosure has been made in consideration of the above-mentioned problems, and an object thereof is to provide an image forming apparatus equipped with a temporary holding mechanism during parts assembly.

The present disclosure provides a method of assembling an image forming apparatus, wherein the image forming apparatus includes: a first part having a first engaging portion and a second engaging portion; a second part having a first engaged portion configured to engage with the first engaging portion and a second engaged portion configured to engage with the second engaging portion, the second part being assembled with the first part; and a third part, and the method includes: a first step of engaging the first engaging portion of the first part with the first engaged portion of the second part by moving the first part in a first direction relative to the second part assembled into a main body of the image forming apparatus; a second step of assembling the third part to the main body by moving the third part in a second direction; and a third step of moving the first part in a third direction relative to the second part so as to release the engagement between the first engaging portion and the first engaged portion and engaging the second engaging portion of the first part with the second engaged portion of the second part.

The present disclosure also provides an image forming apparatus including: a first part having a first engaging portion and a second engaging portion; a second part having a first engaged portion that is capable of being engaged with the first engaging portion and is not being engaged with the first engaging portion, and, a second engaged portion that is being engaged with the second engaging portion.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus according to an embodiment.

FIG. 2 is a diagram showing the arrangement of a paper feed unit as seen from the bottom side of the first embodiment.

FIG. 3 is a diagram explaining the configuration of the paper feed unit of the first embodiment.

FIG. 4 is another diagram explaining the configuration of the paper feed unit of the first embodiment.

FIGS. 5A and 5B are external views of a first paper feed shaft support member of the first embodiment.

FIG. 6 is an external view of a paper feed stay of the first embodiment.

FIG. 7 is a diagram showing the process of assembling the paper feed unit of the first embodiment into the image forming apparatus.

FIG. 8 is a continuation of the diagram explaining the process of assembling the paper feed unit of the first embodiment into the image forming apparatus.

FIG. 9 is a continuation of the diagram explaining the process of assembling the paper feed unit of the first embodiment into the image forming apparatus.

FIG. 10 is a continuation of the diagram explaining the process of assembling the paper feed unit of the first embodiment into the image forming apparatus.

FIGS. 11A to 11C are diagrams showing the process of assembling the paper feed shaft support member into the paper feed stay.

FIG. 12 is a flowchart explaining the process of the first embodiment.

FIG. 13 is a diagram showing the process of assembling the paper feed unit of a comparative example into the image forming apparatus.

FIG. 14 is a continuation of the diagram explaining the process of assembling the paper feed unit of the comparative example into the image forming apparatus.

FIG. 15 is a continuation of the diagram explaining the process of assembling the paper feed unit of the comparative example into the image forming apparatus.

FIG. 16 is a continuation of the diagram explaining the process of assembling the paper feed unit of the comparative example into the image forming apparatus.

FIGS. 17A and 17B are diagrams showing the process of assembling a substrate holder of a second embodiment into the image forming apparatus.

FIGS. 18A and 18B are diagrams showing the process of assembling the substrate holder into the image forming apparatus.

FIGS. 19A to 19C are diagrams showing the process of assembling the substrate holder into the body frame.

### DESCRIPTION OF THE EMBODIMENTS

The following is a detailed description of various embodiments, features, and aspects of the present disclosure, with reference to the drawings. However, unless otherwise specified, the dimensions, materials, shapes, and relative positions of the components described in these embodiments are not intended to limit the scope of the present disclosure to these alone. Furthermore, the materials, shapes, and other aspects of the components described once in the following description are the same as those described initially, unless otherwise specified. In particular, general or known technologies in the technical fields can be applied to configurations and processes which are not specifically illustrated or described. Furthermore, duplicated descriptions may be omitted in some cases.

### First Embodiment

An image forming apparatus according to a first embodiment and its assembling method will be described using figures. Here, the overall configuration of the image forming apparatus according to the present disclosure will be described first, and then a configuration for temporarily holding parts will be described.

Note that the present disclosure is applicable as long as a first part having a plurality of engaging portions is assembled into another part. The target to which the first part is assembled may be a single part (second part). In that case, the second part has a plurality of engaging portions corresponding to a plurality of engaged portions. In addition, a configuration may be adopted in which a plurality of engaging portions (for example, a first engaging portion and a second engaging portion) of the first part are each assembled into another part. In that case, a configuration may be adopted in which the second part has a first engaged portion corresponding to the first engaging portion, and the third part has a second engaged portion corresponding to the second engaging portion. The present disclosure is also applicable to a method of assembling an image forming apparatus having such a configuration. That is, the method is a method of assembling an image forming apparatus having a temporary holding step of temporarily holding the first part, and an assembly step of finally assembling the first part.

### Overall Configuration of Image Forming Apparatus

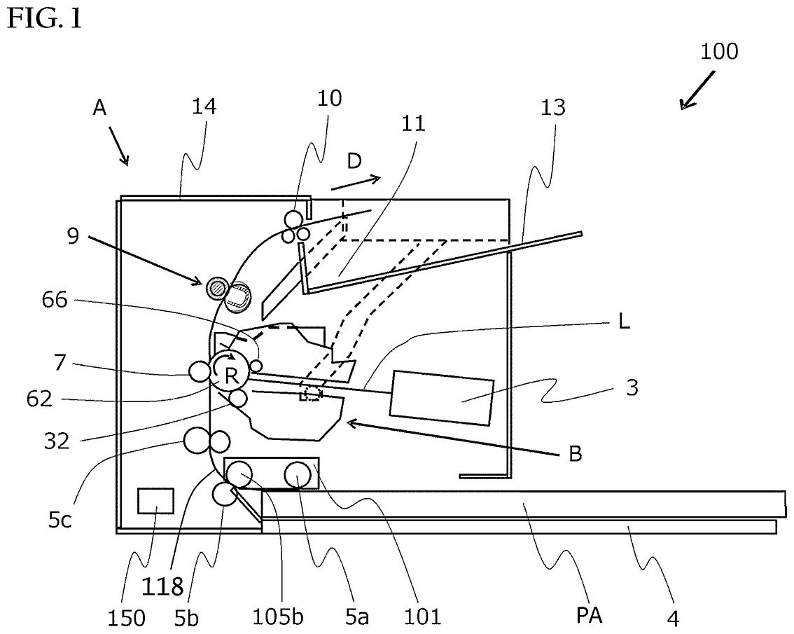

The overall configuration and image forming process will be described with reference to FIG. 1. However, the image forming apparatus according to the present disclosure is not limited to a laser beam printer, and may be applied to other image forming apparatuses such as copiers and facsimiles.

FIG. 1 is a cross-sectional view of an apparatus body A (electrophotographic image forming apparatus body, image forming apparatus body) and a cartridge B (process cartridge) of an electrophotographic image forming apparatus 100 according to the first embodiment. Here, the apparatus body A is the main body part of the image forming apparatus 100 excluding the cartridge B.

The electrophotographic image forming apparatus 100 shown in FIG. 1 is a laser beam printer using electrophotographic technology, in which the cartridge B is detachably mounted to the apparatus body A. The apparatus body A is provided with an exposure device 3 (laser scanner unit) for forming a latent image on an electrophotographic photosensitive drum (hereinafter simply referred to as a photosensitive drum 62) of the cartridge B when the cartridge B is mounted on the apparatus body A. In addition, a sheet tray 4 which stores a recording medium (hereinafter referred to as a sheet material PA) on which an image is to be formed is arranged below the cartridge B. The photosensitive drum 62 is an image bearing member, and is a photosensitive member (electrophotographic photosensitive member) used for electrophotographic image formation.

Furthermore, in the apparatus body A, a pickup roller 5a, an opposing feed roller 5b, a feed roller 105b, a conveying roller pair 5c, a transfer roller 7, a fixing device 9, a discharge roller pair 10, a discharge tray 11, and the like are arranged in order along the conveying direction D of the sheet material PA.

### Image Forming Process Section

Next, an outline of the image forming process will be described. Various operations during the process are executed by a control unit 150 of the image forming apparatus 100 controlling each component according to a program or user instructions. The control unit 150 is an information processing device or processing circuit equipped with computing resources such as a processor and memory.

First, based on a print start signal from the control unit 150, the photosensitive drum 62 is rotated in the direction of arrow R at a predetermined peripheral speed (process speed). A charging roller 66 (charging member) to which a bias voltage is applied contacts the outer peripheral surface of the photosensitive drum 62 and uniformly charges the outer peripheral surface of the photosensitive drum 62.

The exposure device 3 outputs a laser beam L according to image information. The laser beam L passes through the laser aperture of the cartridge B and scans and exposes the outer peripheral surface of the photosensitive drum 62. As a result, an electrostatic latent image corresponding to the image information is formed on the outer peripheral surface of the photosensitive drum 62.

Meanwhile, the toner in the cartridge B is borne on the developing roller 32 and supplied to the photosensitive drum 62 to develop the latent image. As a result, the latent image is visualized as a toner image.

In addition, in synchronization with the output timing of the laser beam L, the sheet material PA stored in the lower part of the apparatus body A is sent out from the sheet tray 4 by the pickup roller 5a, the opposing feed roller 5b, the feed roller 105b, and the conveying roller pair 5c attached to the paper feed unit 101. Then, the sheet material PA is conveyed to the transfer position between the photosensitive drum 62 and the transfer roller 7. At this transfer position, the toner image is sequentially transferred from the photosensitive drum 62 to the sheet material PA.

The sheet material PA to which the toner image has been transferred is separated from the photosensitive drum 62 and conveyed to the fixing device 9. Then, the sheet material PA is subjected to a pressure and heat fixing process in the nip portion constituting the fixing device 9. As a result, the toner image is fixed to the sheet material PA. The sheet material PA to which the toner image has been fixed is discharged to the discharge tray 11 by the discharge roller pair 10.

### Configuration of Paper Feed Unit and Paper Feed Stay

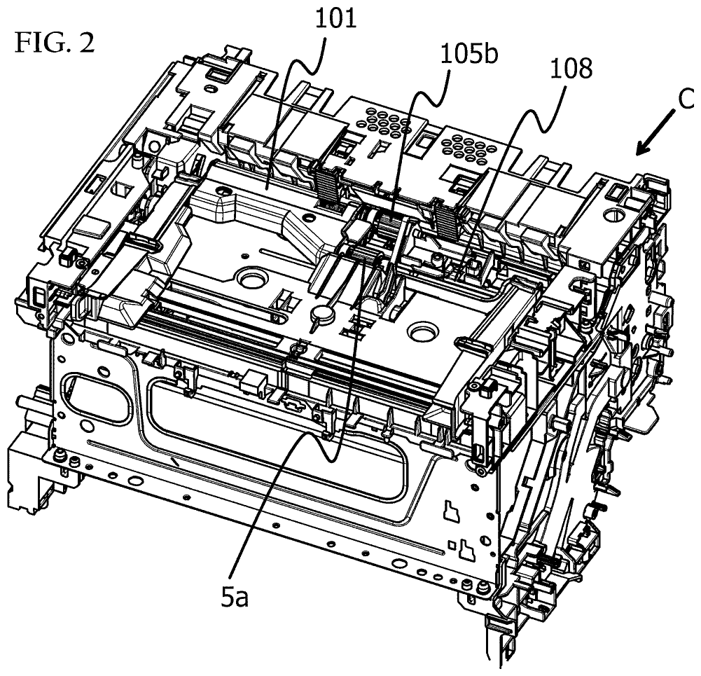

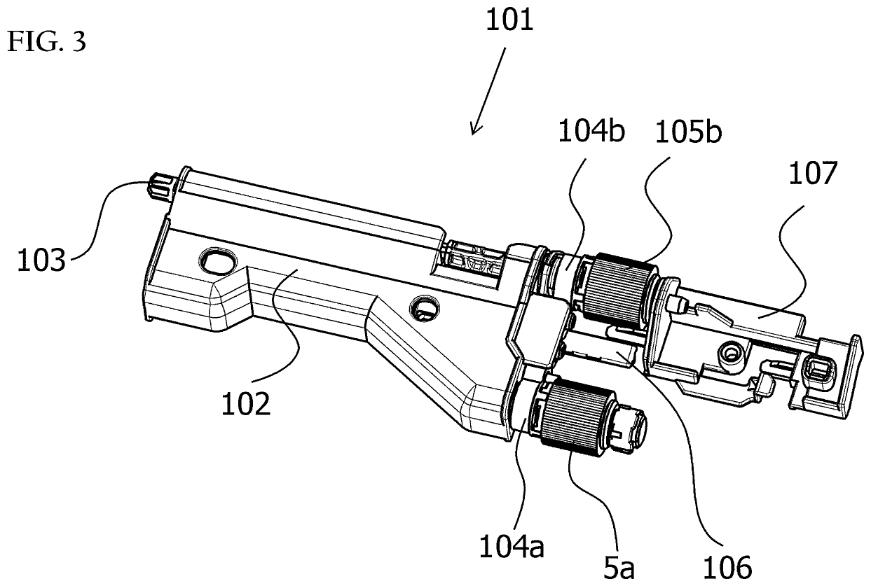

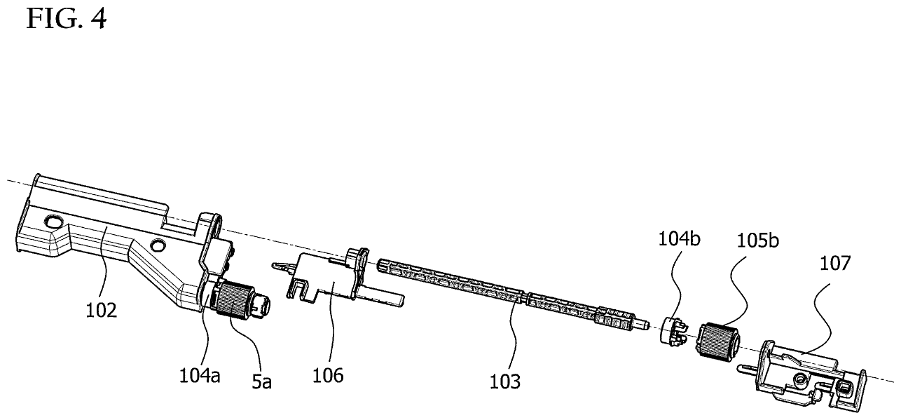

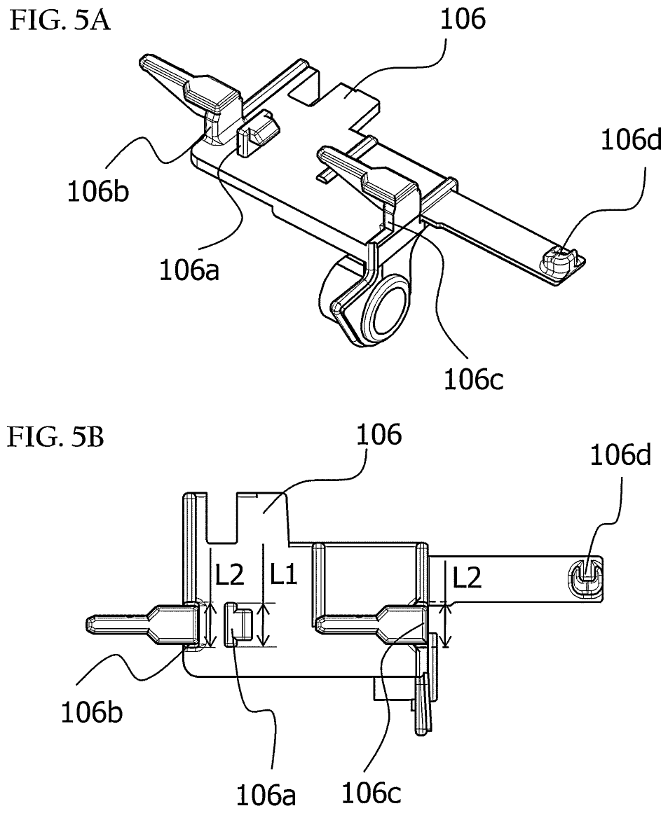

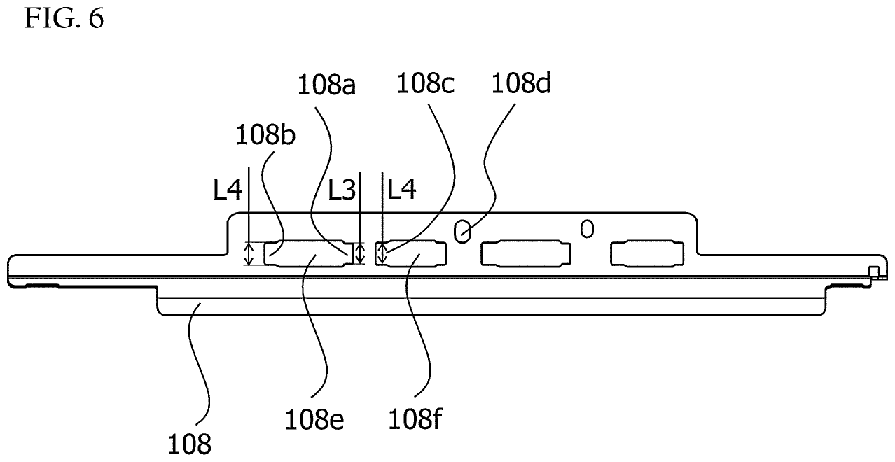

Next, the configuration of the paper feed unit and paper feed stay of the image forming apparatus 100 will be described. FIG. 2 is a diagram showing the arrangement of the paper feed unit as seen from the bottom side in the first embodiment. FIGS. 3 and 4 are diagrams showing the configuration of the paper feed unit in the first embodiment. FIGS. 5A and 5B are external views of a first paper feed shaft support member in the first embodiment. FIG. 6 is an external view of the paper feed stay in the first embodiment.

FIG. 2 is a diagram showing the image forming apparatus as seen from the bottom side, in which the paper feed unit 101 and the paper feed stay 108 are attached to the pre-assembly apparatus body C. The paper feed stay 108 is a metal plate to which the paper feed unit 101 is attached, and the paper feed unit 101 is equipped with the pickup roller 5a and the feed roller 105b that conveys the sheet material PA to the conveying roller pair 5c. Here, the pre-assembly apparatus body C refers to a state before and after the paper feed unit 101 is assembled into the image forming apparatus, with the cartridge B excluded from the image forming apparatus, and has fewer assembled parts than the apparatus body A.

Here, a configuration is described in which the paper feed unit 101 as the first part is assembled into the pre-assembly apparatus body C as the second part. However, the second part does not have to be a single part, and for example, a first engaged portion and a second engaged portion may be provided on different parts.

FIG. 3 shows an external perspective view of the paper feed unit 101. FIG. 4 shows an exploded view of the paper feed unit 101. As shown in FIG. 3, the paper feed unit 101 has a paper feed arm 102, a paper feed shaft 103, paper feed gears 104a and 104b, a pickup roller 5a, a feed roller 105b, a first paper feed shaft support member 106, and a second paper feed shaft support member 107.

The paper feed shaft 103 is a shaft that transmits the rotational drive to the feed roller 105b, the paper feed gear 104b is a gear that transmits the rotational drive of the paper feed shaft 103 to the paper feed gear 104a, and the pickup roller 5a is a roller that feeds the sheet material PA. The feed roller 105b is a roller that conveys the sheet material PA conveyed by the pickup roller 5a to the conveying roller pair 5c in the apparatus body A. The first paper feed shaft support member 106 and the second paper feed shaft support member 107 are parts that are attached to the paper feed shaft 103 and are positioned on the paper feed stay 108 in the pre-assembly apparatus body C. The paper feed arm 102 is a part that includes the paper feed gear 104a and the pickup roller 5a and is attached to the first paper feed shaft support member 106.

As shown in FIG. 4, the paper feed shaft 103 is attached to the paper feed gear 104b, the feed roller 105b, the first paper feed shaft support member 106, and the second paper feed shaft support member 107. The paper feed arm 102 is attached to the first paper feed shaft support member 106, the paper feed arm 102 is attached to the paper feed gear 104a and the pickup roller 5a, and the paper feed gear 104a is connected to the paper feed gear 104b by a gear drive train. Therefore, when the paper feed shaft 103 rotates, the feed roller 105b and the paper feed gear 104b rotate, and the paper feed gear 104a connected to the paper feed gear 104b by a gear drive train and the pickup roller 5a coaxial with the paper feed gear 104a rotate.

FIG. 5A shows an external perspective view of the first paper feed shaft support member 106. FIG. 5B shows a front view of the first paper feed shaft support member 106.

The first paper feed shaft support member 106 shown in FIG. 5A is provided with a first engaging portion 106a that is L-shaped in side view, and this shape is for temporarily holding the first paper feed shaft support member 106 on the paper feed stay 108. The first paper feed shaft support member 106 is also provided with second engaging portions 106b and 106c that are L-shaped in side view and a positioning boss 106d, and this shape is for positioning the first paper feed shaft support member 106 on the paper feed stay 108.

As shown in FIG. 5B, the width of the shape of the first engaging portion 106a that engages with the paper feed stay 108 is indicated as L1, and the width of the shape of the second engaging portions 106b and 106c that engage with the paper feed stay 108 is indicated as L2.

In the paper feed stay 108 shown in FIG. 6, the width of the first engaged portion 108a that engages with the first engaging portion 106a of the first paper feed shaft support member 106 is indicated as L3. The first engaged portion 108a is provided at one end of a hole 108e that has a shape having a long side and a short side. In addition, the width of the second engaged portions 108b and 108c that engage with the second engaging portions 106b and 106c of the first paper feed shaft support member 106 is indicated as L4. The second engaged portion 108b is provided at the other end of the hole 108e. The second engaged portion 108c is provided at one end of a hole 108f having a shape with a long side and a short side. The holes 108e and 108f are arranged on the paper feed stay 108 so that the long side direction and the short side direction are aligned and the other hole is located on the extension of one of the long sides. The second engaged portions 108b and 108c are provided on the same side in the long side direction (the left side in the figure) of the holes 108e and 108f, respectively. The paper feed stay 108 also has a positioning hole 108d that engages with the positioning boss 106d.

In this embodiment, the width L1 of the first engaging portion 106a of the first paper feed shaft support member 106 is set to be larger than the width L3 of the first engaged portion 108a of the paper feed stay 108 (L1>L3). Therefore, the first engaging portion 106a is lightly press-fitted into the first engaged portion 108a and temporarily held. It is preferable that the widths of L1 and L3 are set to such an extent that the first engaging portion 106a is lightly press-fitted into the first engaged portion 108a, and the widths are appropriately set according to the material of each member.

In addition, since the width L2 of the second engaging portions 106b and 106c of the first paper feed shaft support member 106 is set smaller than the width L4 of the second engaged portions 108b and 108c of the paper feed stay 108 (L2<L4), the second engaging portions 106b and 106c are positioned by fitting into the second engaged portions 108b and 108c.

It is also possible to consider a configuration in which the first engaging portion 106a engages with both the first engaged portion 108a and the second engaged portion 108b. However, after the light press-fit between the first engaging portion 106a and the first engaged portion 108a is released, the first engaging portion 106a is scraped off and becomes smaller than the width L1. Therefore, if the first engaging portion 106a is positioned by fitting into the second engaged portion 108b when the width L1 of the first engaging portion 106a is reduced, the mounting position of the parts will change, resulting in problems such as a deterioration in printing accuracy. Therefore, it is preferable to avoid engaging the first engaging portion 106a with the second engaged portion 108b.

### Description of Paper Feed Unit Assembly

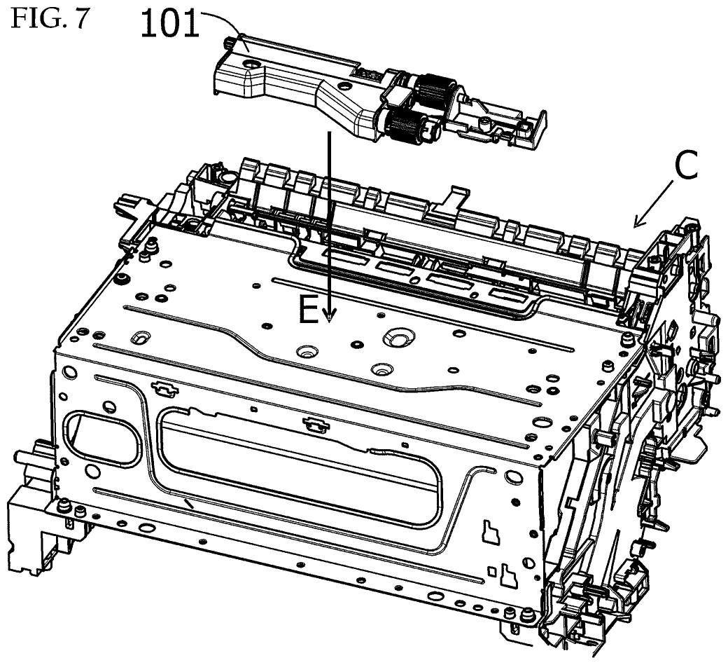

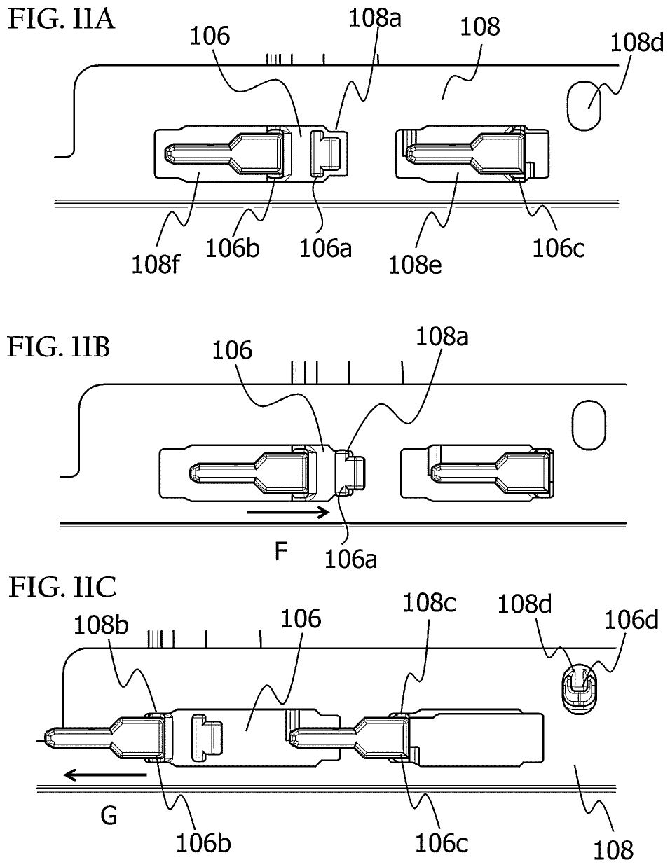

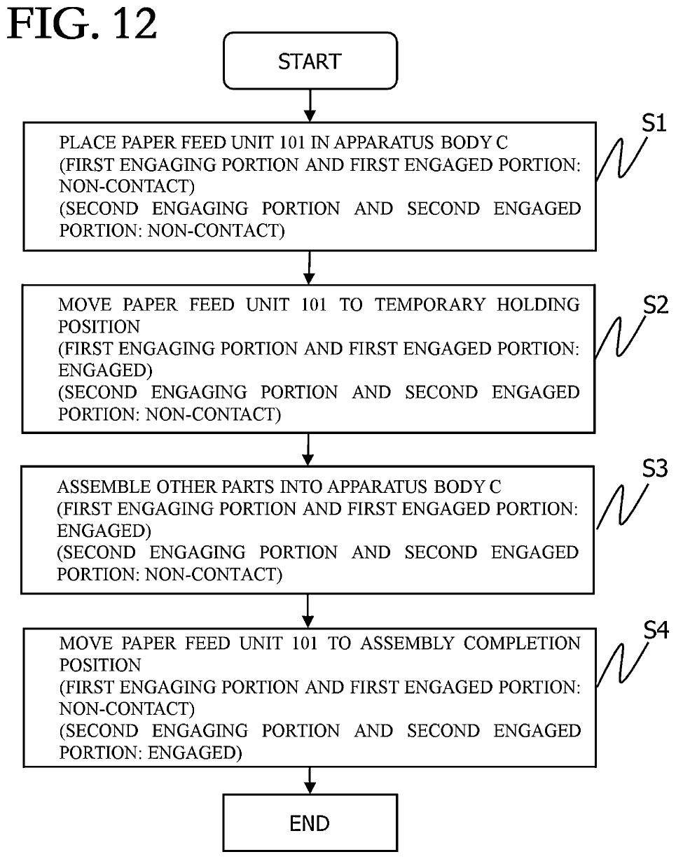

Next, the assembly operation of the paper feed unit according to this embodiment, the temporary holding operation, and the assembly completion operation will be described. FIGS. 7 to 10 are diagrams explaining the process of assembling the paper feed unit into the image forming apparatus. FIGS. 11A to 11C are diagrams explaining the process of assembling the first paper feed shaft support member into the paper feed stay. FIG. 12 is a flowchart explaining the process of assembling the first paper feed shaft support member into the paper feed stay.

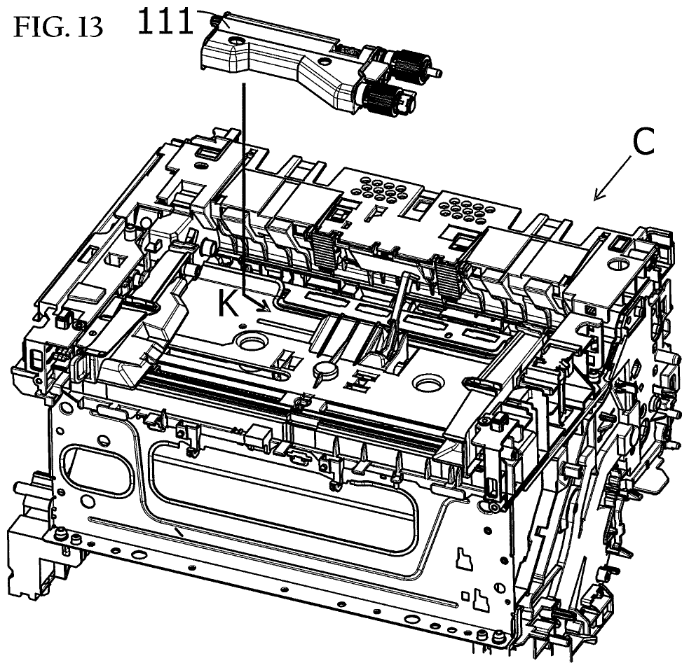

Furthermore, FIGS. 13 to 16 are diagrams explaining the process of assembling the paper feed unit into the image forming apparatus when the configuration of this embodiment is not used.

In this embodiment, first, as shown in FIG. 7, the paper feed unit 101 is placed in the pre-assembly apparatus body C in the direction of arrow E. At that time, as shown in FIG. 11A, the protruding portions of the first engaging portion 106a and the second engaging portions 106b and 106c of the first paper feed shaft support member 106 are stationary in the holes 108e and 108f of the paper feed stay 108 (FIG. 12, START→step S1)

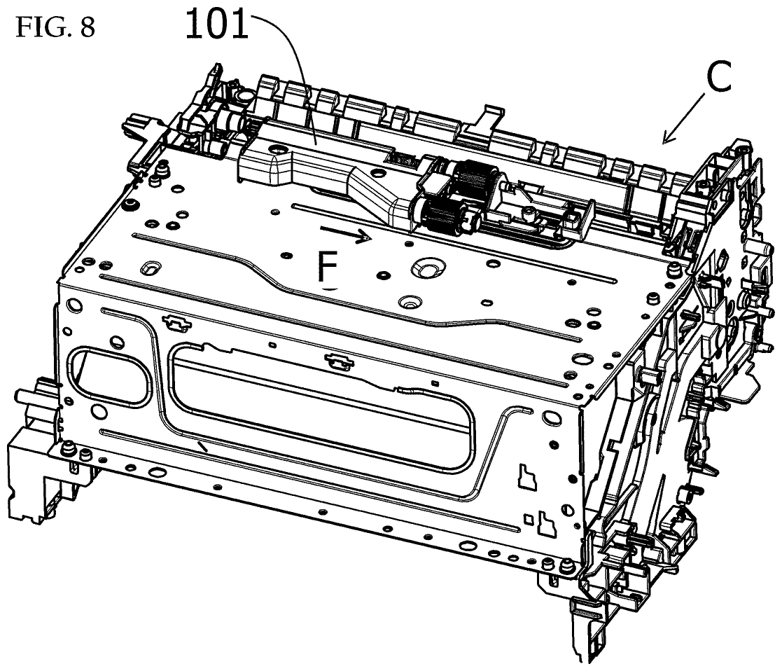

Next, as shown in FIG. 8, after placing the paper feed unit 101 on the paper feed stay 108, a paper feed shaft support R106 is temporarily held by the paper feed stay 108 by moving the paper feed unit 101 in the direction of arrow F. At that time, as shown in FIG. 11B, the first engaging portion 106a of the first paper feed shaft support member 106 moves in the direction of arrow F and is lightly press-fitted into and engaged with the first engaged portion 108a of the paper feed stay 108. Here, as shown in FIGS. 3 and 4, the second paper feed shaft support member 107 can be removed from the paper feed shaft 103 in the direction of arrow F. However, the first paper feed shaft support member 106 is lightly press-fitted into the paper feed stay 108 and temporarily held therein, which restricts the amount of movement of the second paper feed shaft support member 107 and prevents the second paper feed shaft support member 107 from coming off (FIG. 12, step S1→step S2). S2 corresponds to the first step.

In this state, the first engaging portion 106a and the first engaged portion 108a are lightly press-fitted into each other, so the first paper feed shaft support member 106 is held by the paper feed stay 108 and will not come off unless a certain amount of pressure (opposite to the direction of arrow F) is applied to the first paper feed shaft support member 106.

By doing so, even if some external force is applied to the pre-assembly apparatus body C in the subsequent assembly work, the first paper feed shaft support member 106 will not come off from the paper feed stay 108, so it is possible to prevent the first paper feed shaft support member 106 from coming off during the assembly work and interfering with the assembly work of other parts.

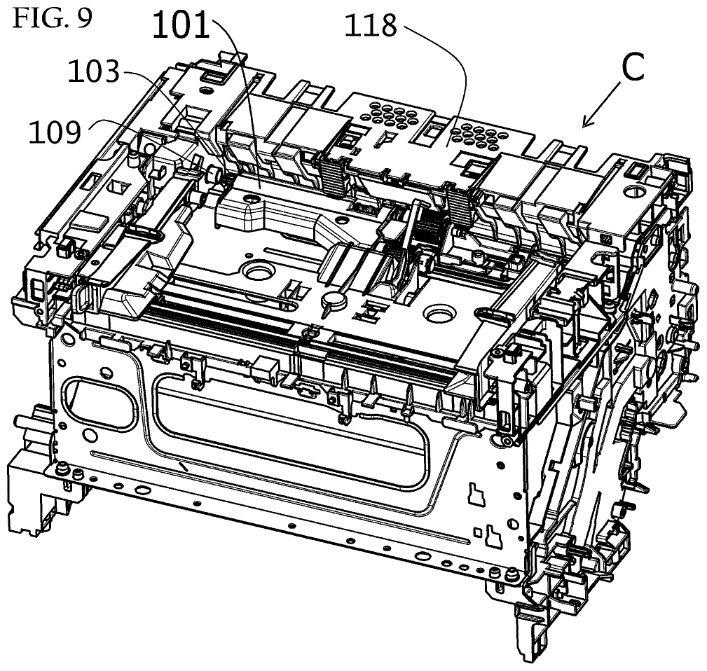

Next, as shown in FIG. 9, in a state in which the paper feed unit 101 is temporarily held in the pre-assembly apparatus body C, other parts of the image forming apparatus are assembled. At that time, the first paper feed shaft support member 106 maintains the state of FIG. 11B (FIG. 12, step S2→step S3). The other parts include, for example, a conveying guide 118. As shown in FIG. 1, the conveying guide 118 is a part that guides conveying between the opposing feed roller 5b and the conveying roller pair 5c when the sheet material PA loaded on the sheet tray 4 is conveyed to the conveying roller pair 5c by the pickup roller 5a and the opposing feed roller 5b. S3 corresponds to the second step.

Here, in the posture during assembly of the parts, the conveying guide 118 has an overlapping portion that overlaps with the paper feed unit 101 in the direction of gravity. This overlapping portion corresponds to a third part. The conveying guide 118 itself, including the overlapping portion, may be considered as a third part. Therefore, if there was no temporary holding mechanism for the paper feed unit 101, after assembling the conveying guide 118, the worker would need to move the paper feed unit 101 in a direction different from the direction of gravity so as to enter the gap between the conveying guide 118 and the pre-assembly apparatus body C.

On the other hand, if there is a temporary holding mechanism, the worker can naturally move the paper feed unit 101 in the direction of gravity before assembling the conveying guide 118. Then, the paper feed unit 101 is moved in a horizontal direction (in the first direction indicated by arrow F) and temporarily held, and then various components such as the conveying guide 118 are assembled. In assembling the conveying guide 118 into the main body, the second direction, which is the moving direction of the conveying guide 118, is different from the first direction and the third direction described later. The second direction may be the direction of gravity, and in that case, the conveying guide 118 is assembled into the main body so that at least a part of the conveying guide 118 overlaps with the paper feed unit 101 when seen in the second direction. In the assembled state, the third part is downstream of the first part and faces the first part in the direction of gravity.

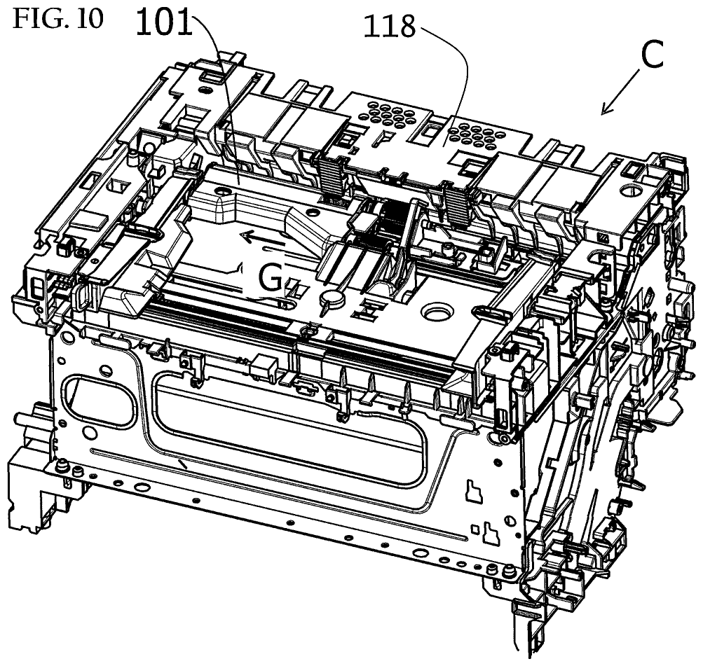

Then, as shown in FIG. 10, the paper feed unit 101 is moved in the direction of arrow G (a third direction opposite to the first direction) different from the direction of arrow F (the first direction), and the assembly of the paper feed shaft support R106 into the paper feed stay 108 is completed. The first direction and the third direction may be horizontal directions. In that case, the first direction and the third direction may be opposite directions. At that time, as shown in FIG. 11C, the second engaging portions 106b and 106c of the first paper feed shaft support member 106 move in the direction of arrow G and engage with the second engaged portions 108b and 108c of the paper feed stay 108. In addition, the positioning boss 106d of the first paper feed shaft support member 106 engages with the positioning hole 108d of the paper feed stay 108, and the positioning is performed. In addition, when the paper feed unit 101 is moved in the direction of arrow G, the paper feed shaft 103 shown in FIGS. 3 and 4 engages with a gear coupling mechanism 109 shown in FIG. 9, enabling drive transmission, and the assembly of the paper feed shaft 103 is completed.

The gear coupling mechanism 109 is a mechanism that includes a hole through which one end of the paper feed shaft 103 is inserted and a coupling portion at the tip of the hole. If the paper feed shaft 103 is the third engaging portion of the paper feed unit 101, the coupling mechanism 109 corresponds to the third engaged portion that engages with the paper feed shaft 103 on the apparatus body side. In the axial direction of the paper feed shaft, the first engaging portion is located between the second engaging portion and the third engaging portion. The paper feed shaft 103 is a shaft that receives drive from the drive portion, and the first direction is the direction of the shaft. In this case, the assembly of the paper feed shaft 103 cannot be completed without movement in the direction of arrow G shown in FIG. 10. Therefore, after waiting for the completion of the assembly of the parts that transmit drive into the paper feed shaft 103 in FIG. 9, it is necessary to move the paper feed unit 101 in the direction of arrow G in FIG. 10 (FIG. 12, step S3→step S4). S4 corresponds to the third step.

In this embodiment, the movement direction for temporary holding (direction of arrow F) and the movement direction for completing assembly (direction of arrow G) are opposite to each other, but depending on the shape of the paper feed stay 108, it is possible to make them the same direction or perpendicular to the direction of arrow G.

### Comparative Example

FIGS. 13 to 16 show explanatory diagrams for assembling the paper feed unit into the pre-assembly apparatus body C when this embodiment is not used.

When this embodiment is not used, a paper feed unit 111, in which the second paper feed shaft support member 107 is removed from the paper feed unit 101, is placed on the pre-assembly apparatus body C along the trajectory in the direction of arrow K as shown in FIG. 13. The reason why it cannot be placed straight like the direction of arrow E in FIG. 7 is that a complex trajectory is required so as not to collide with the parts assembled into the pre-assembly apparatus body C in FIG. 9. With the trajectory in the direction of arrow K, the paper feed unit 111 cannot be assembled quickly and easily, and the assembly speed decreases.

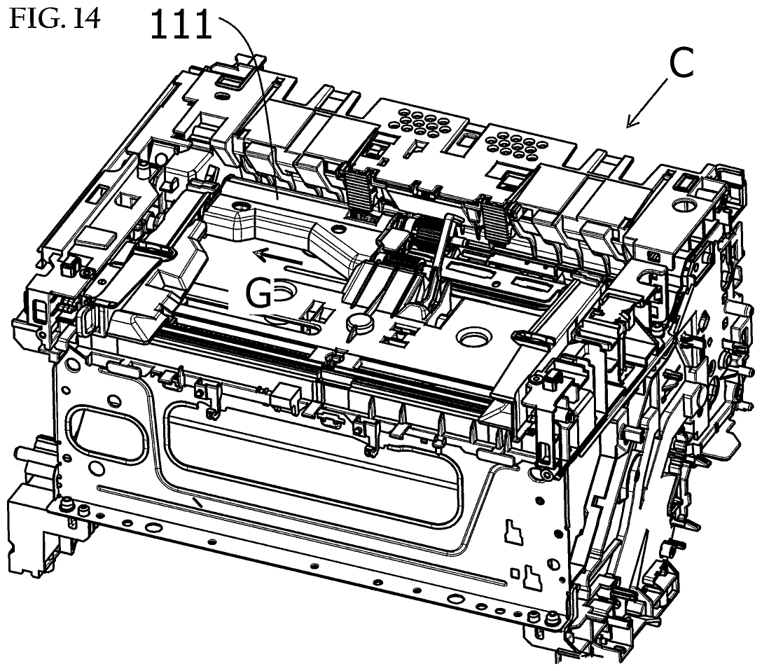

Next, as shown in FIG. 14, the paper feed unit 111 is moved in the direction of arrow G, and the first paper feed shaft support member 106 is assembled into the paper feed stay 108.

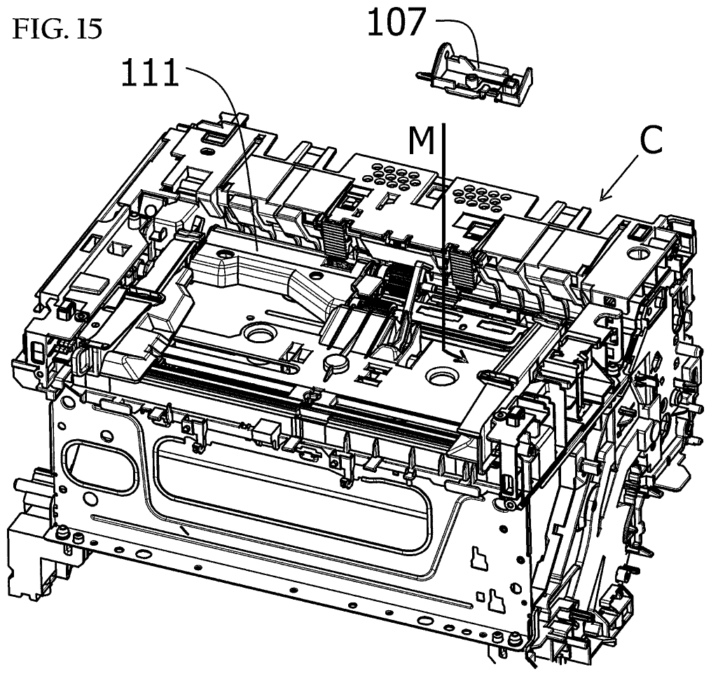

Next, as shown in FIG. 15, the second paper feed shaft support member 107 is placed on the pre-assembly apparatus body C along a trajectory in the direction of arrow M. Here, as with the paper feed unit 111 in FIG. 13, it cannot be placed straight because a complex trajectory is required so as not to collide with the parts assembled into the pre-assembly apparatus body C in FIG. 9, which slows down the assembly speed.

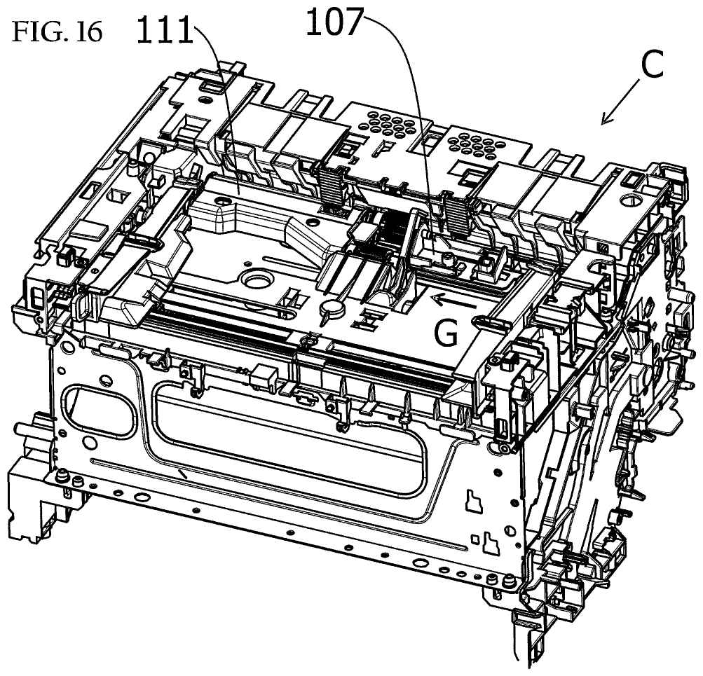

Then, as shown in FIG. 16, the paper feed unit 111 is moved in the direction of arrow G, and the second paper feed shaft support member 107 is assembled into the paper feed stay 108.

As a result, in the case of the comparative example as shown in FIGS. 13 to 16, an assembly trajectory that is aimed at a limited gap is required so as not to collide with the parts already assembled, which slows down the assembly speed. Conversely, by using the configuration of this embodiment, the order of parts assembly can be changed, making it possible to further increase the assembly speed.

### Effects of This Embodiment

With the above-described configuration, when assembling the paper feed unit 101 into the pre-assembly apparatus body C, the first engaging portion 106a of the first paper feed shaft support member 106 is lightly press-fitted into and engaged with the first engaged portion 108a of the paper feed stay 108, so that the paper feed unit 101 can be temporarily held in the pre-assembly apparatus body C. By doing so, it is possible to assemble other surrounding parts of the image forming apparatus while the paper feed unit 101 is temporarily held as shown in FIG. 9, and to complete the assembly of the paper feed unit 101 when this is completed.

If other parts of the image forming apparatus are assembled before assembling the paper feed unit 101, the assembly trajectory of the paper feed unit 101 will interfere with the other parts. As a result, it may become impossible to place the paper feed unit 101 in the pre-assembly apparatus body C, or the assembly trajectory may be aimed at a limited gap, which slows down the assembly speed. On the other hand, if the paper feed unit 101 is assembled first, there is a concern that the paper feed unit 101 may come off from the pre-assembly apparatus body C during the assembly of other parts. Thus, a function for temporarily holding the paper feed unit 101 on the pre-assembly apparatus body C is necessary. If space is secured around the paper feed unit 101 to ensure assembly space, the paper feed unit 101 can be assembled, but this increases the size of the image forming apparatus and increases costs. In addition, the paper feed unit 101 can be temporarily held by using an assembly jig or a separate part that temporarily holds the paper feed unit 101 during assembly, but this increases the number of assembly steps, which increases the cost of assembly.

Therefore, in this embodiment, a configuration is adopted in which a temporary holding engaging portion and an assembly completion engaging portion are provided on the parts when assembling parts into the image forming apparatus. Then, the assembly completion engaging portion is not used when the temporary holding engaging portion is used, and the temporary holding engaging portion is not used when the assembly completion engaging portion is used. By doing so, even if the parts are arranged in a narrow space, the paper feed unit can be temporarily held and assembled. As a result, it is possible to prevent the image forming apparatus from becoming larger due to the need for assembly space, and to prevent the cost from increasing due to the need to use additional parts for assembly work.

### Second Embodiment

In the first embodiment, a case where a paper feed unit is assembled into an image forming apparatus has been described. However, the units and parts to be assembled are not limited to the paper feed unit, and any parts that can be attached to and detached from an image forming apparatus may be used. For example, the present disclosure can be applied when assembling a substrate holder of a main body unit into a body frame.

Next, the assembly operation of the substrate holder and the body frame according to the second embodiment, and the temporary holding and assembly completion operations will be described. The assembly operation is performed in the order of (1) attaching the substrate holder, (2) moving the substrate holder to the temporary holding position, (3) attaching the cables to the electric substrate of the substrate holder, and (4) moving the substrate holder to the assembly completion position.

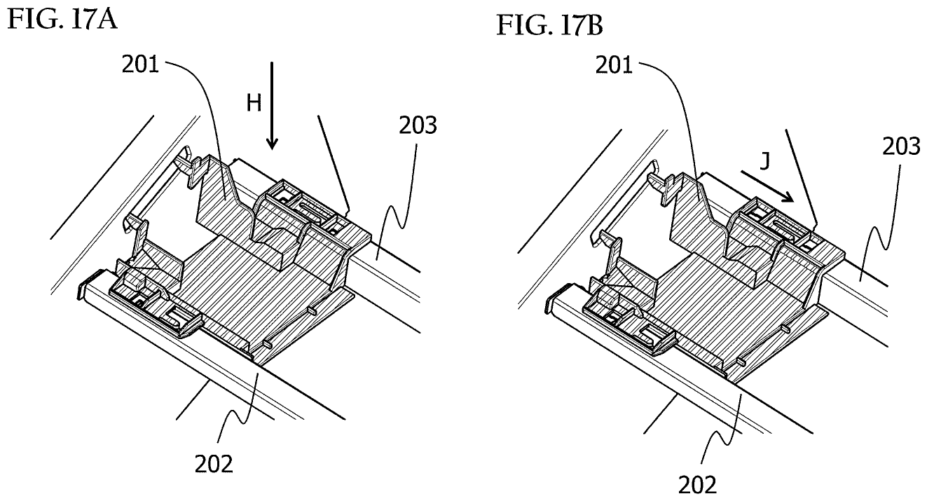

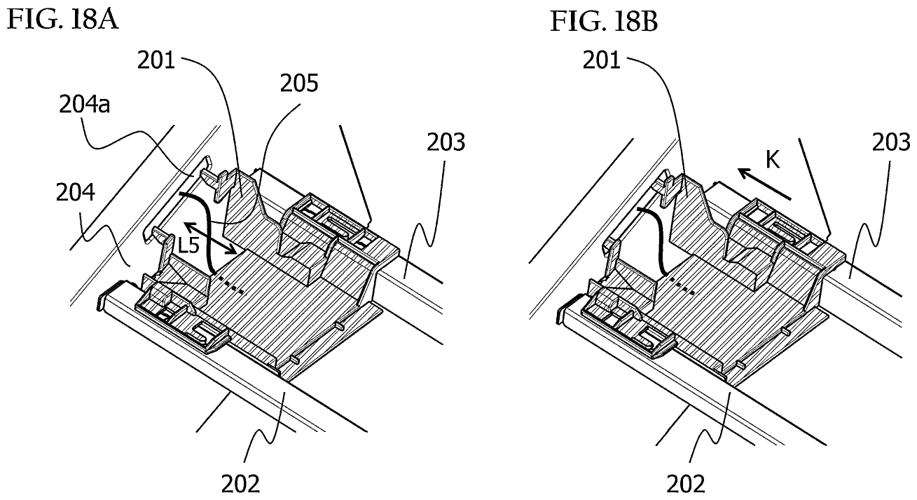

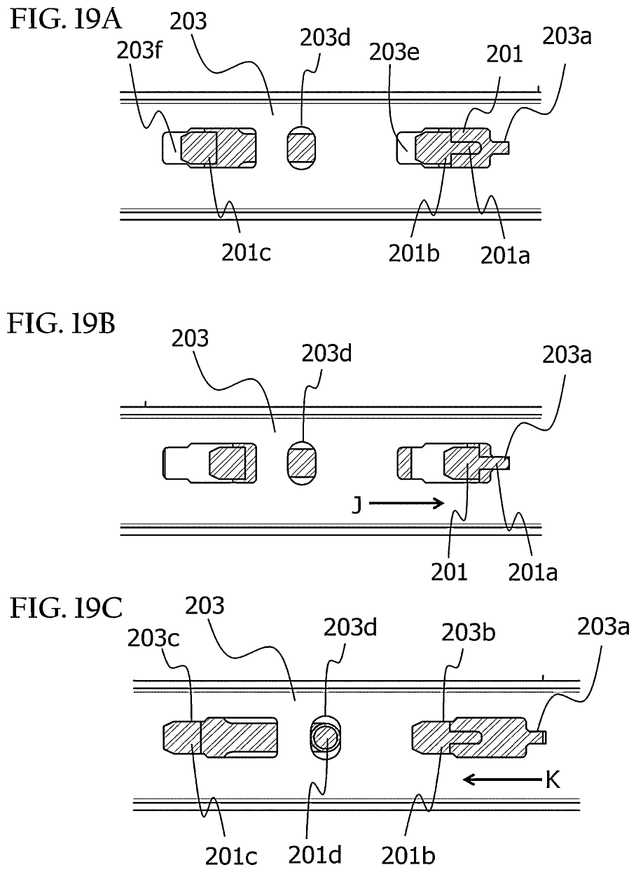

FIGS. 17A, 17B, 18A, and 18B are diagrams explaining the process of assembling the substrate holder into an image forming apparatus. FIGS. 19A to 19C are diagrams for explaining the process of assembling the substrate holder into a body frame formed by assembling a first body frame 202 and a second body frame 203 into a third body frame 204.

(1) First, as shown in FIG. 17A, the substrate holder 201 is placed on the first body frame 202 and the second body frame 203 in the direction of arrow H. At that time, as shown in FIG. 19A, the protruding portions of the first engaging portion 201a and the second engaging portions 201b and 201c of the substrate holder 201 are stationary in the holes 203e and 203f of the second body frame 203.

Next, as shown in FIG. 17B, the substrate holder 201 is moved in the direction of arrow J, so that the substrate holder 201 is temporarily held by the second body frame 203. At this time, as shown in FIG. 19B, the first engaging portion 201a of the substrate holder 201 moves in the direction of arrow J and is lightly press-fitted into and engaged with the first engaged portion 203a of the second body frame 203.

In this state, the first engaging portion 201a and the first engaged portion 203a are lightly press-fitted into each other, so the substrate holder 201 is held by the second body frame 203. At this time, the substrate holder 201 will not come off from the second body frame 203 unless a certain amount of pressure (in the direction opposite to arrow J) is applied.

Next, as shown in FIG. 18A, with the substrate holder 201 temporarily held by the second body frame 203, the cable 205 is passed through the hole 204a of the third body frame 204. Then, the cable 205 is connected to the cable connector of the electric substrate (not shown) attached to the substrate holder 201. At this time, the substrate holder 201 maintains the state shown in FIG. 19B. Therefore, the gap L5 between the substrate holder 201 and the third body frame 204 is wider than that in FIG. 17A, and it is possible to secure a working space for passing the cable 205 through the gap L5 and connecting it to the cable connector of the electric substrate (not shown).

Then, as shown in FIG. 18B, the substrate holder 201 is moved in the direction of arrow K, and the substrate holder 201 is completely assembled into the second body frame 203. At that time, as shown in FIG. 19C, the second engaging portions 201b and 201c of the substrate holder 201 move in the direction of arrow K and engage with the second engaged portions 203b and 203c of the second body frame 203. In addition, the positioning boss 201d of the substrate holder 201 engages with the positioning hole 203d of the second body frame 203, and the substrate holder 201 is positioned.

### Effects of This Embodiment

With the above-described configuration, when the substrate holder 201 is assembled into the body frame, the first engaging portion 201a of the substrate holder 201 is lightly press-fitted into and engaged with the first engaged portion 203a of the second body frame 203, so that the substrate holder 201 can be temporarily held on the second body frame 203.

By doing so, as shown in FIG. 18A, the gap L5 between the substrate holder 201 and the third body frame 204 is wider than that in FIG. 17A. This makes it possible to secure a working space for passing the cable 205 through the gap L5 and connecting it to the cable connector of the electric substrate (not shown). By securing the working space, it becomes possible to insert a finger into the gap L5 and pass the cable 205 through the gap L5 to connect it to the cable connector of the electric substrate (not shown).

Here, if the length of the cable 205 is designed to be the minimum necessary to reduce costs, the cable 205 may not be able to be assembled before the substrate holder 201 is assembled into the second body frame 203 because the cable length is insufficient. Or, even if the substrate holder 201 can be assembled into the second body frame 203, the cable may come off while the substrate holder 201 is being assembled into the second body frame 203.

By adopting the configuration of the second embodiment, it is possible to reduce the cost of the cable and improve the assembly stability while preventing the main body from becoming larger due to the need to secure assembly space.

According to the present disclosure, it is possible to provide an image forming apparatus equipped with a temporary holding mechanism during part assembly.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-021767, filed on Feb. 16, 2024, which is hereby incorporated by reference herein in its entirety.

What is claimed is:

1. A method of assembling an image forming apparatus, wherein
the image forming apparatus including:
a first part having a first engaging portion and a second engaging portion;
a second part having a first engaged portion configured to engage with the first engaging portion and a second engaged portion configured to engage with the second engaging portion, the second part being assembled with the first part; and
a third part,
the method comprising:
a first step of engaging the first engaging portion of the first part with the first engaged portion of the second part by moving the first part in a first direction relative to the second part assembled into a main body of the image forming apparatus;
a second step of assembling the third part to the main body by moving the third part in a second direction; and
a third step of moving the first part in a third direction relative to the second part so as to release the engagement between the first engaging portion and the first engaged portion and engaging the second engaging portion of the first part with the second engaged portion of the second part.

2. The method of assembling the image forming apparatus according to claim 1, wherein
the second direction is the direction of gravity, and
in the second step, the third part is assembled into the main body so as to overlap with the first part when seen in the second direction.

3. The method of assembling the image forming apparatus according to claim 2, wherein
the first direction and the third direction are horizontal directions, and
the first direction is opposite to the third direction.

4. The method of assembling the image forming apparatus according to claim 3, wherein
the main body has a third engaged portion,
the first part has a third engaging portion engaged with the third engaged portion,
in the first direction, the second engaging portion is located between the first engaging portion and the third engaging portion, and
in the third step, the first part is moved in the third direction relative to the second part so as to release the engagement between the first engaging portion and the first engaged portion, so that the third engaging portion engages with the third engaged portion.

5. The method of assembling the image forming apparatus according to claim 4, wherein
the first part is a paper feed unit for feeding a recording material,
the paper feed unit has a shaft that receives drive, and
the first direction is the direction of the shaft.

6. The method of assembling the image forming apparatus according to claim 4, wherein
the first part is a substrate holder that is attached to a body frame of the image forming apparatus.

7. The method of assembling the image forming apparatus according to claim 1, wherein
one of the first engaging portion and the first engaged portion has a hole shape and the other has a protruding portion that fits into the hole, and
when the first engaging portion and the first engaged portion engage with each other, they are in a lightly press-fit state.

8. An image forming apparatus comprising:
a first part having a first engaging portion and a second engaging portion;
a second part having a first engaged portion that is capable of being engaged with the first engaging portion and is not being engaged with the first engaging portion, and, a second engaged portion that is being engaged with the second engaging portion.

9. The image forming apparatus according to claim 8, further comprising:
a third part that is downstream of the first part in the direction of gravity and faces the first part in the direction of gravity.

10. The image forming apparatus according to claim 9, further comprising:
a third engaging portion, wherein
the first part having a third engaging portion that is being engaged with the third engaged portion, and
the second engaging portion is located between the first engaging portion and the third engaging portion in a first direction that is a horizontal direction.

11. The image forming apparatus according to claim 10, wherein
the first part that is a paper feed unit that feeds a recording material,
the paper feed unit has a shaft that receives drive, and
the first direction is the direction of the shaft.

12. The image forming apparatus according to claim 10, wherein
the first part is a substrate holder that is attached to a body frame of the image forming apparatus.

13. The image forming apparatus according to claim 8, wherein
one of the first engaging portion and the first engaged portion has a hole shape and the other has a protruding portion that fits into the hole, and
when the first engaging portion and the first engaged portion engage with each other, they are in a lightly press-fit state.
